(19) United States
(12) Patent Application Publication
(10) Pub. No.: US 2021/0072881 A1
(43) Pub. Date: Mar. 11, 2021

(54) Unified Computing Device Interface for Choosing from a Plurality of Source Entities for Association with a Plurality of Destination Entities

(71) Applicant: Charles Russell McNeill, Silver Spring, MD (US)

(72) Inventor: Charles Russell McNeill, Silver Spring, MD (US)

(21) Appl. No.: 17/028,853

(22) Filed: Sep. 22, 2020

Related U.S. Application Data
(63) Continuation-in-part of application No. 16/563,103, filed on Sep. 6, 2019, now Pat. No. 10,819,669.

(51) Int. Cl. G06F 3/0484; G06F 9/451

(52) U.S. Cl. CPC G06F 3/04842; G06Q 50/04; G06F 9/451

(57) ABSTRACT

Disclosed herein is a unified graphical user interface for computing devices, enabling configuration of multiple source entities and destination entities for purposes of signal routing, options selections, and variably-mixed combinations of options. Source entities may be signals such as audio, video, timing sources, voltages or other non-binary sources. Destinations may be any signal input port or channel, connection node, or a form of result of combinations of options, such as in vending or manufacturing. Icons representing one or more source entities, and one or more destination entities are associated by user actions in the interface to establish the association to be executed. Embodiments described include those suited to both cursor-controlled devices and touchscreen-controlled devices.

### RELATED APPLICATIONS

This application is a Continuation-in-Part of application Ser. No. 16/563,103, filed Sep. 6, 2019 and currently in NOA status, which is a continuation of application Ser. No. 15/995,077, filed May 31, 2018 and now granted U.S. Pat. No. 10,454,858 B2, which is a continuation of application Ser. No. 15/646,029, filed Jul. 10, 2017 and now granted U.S. Pat. No. 10,019,133 B1, both entitled “Unified Computing Device Interface for Assembly of a Plurality of Types of Digital Content for Transmission to a Plurality of Target Destinations,” and claims priority to Provisional Application No. 62/480,519, filed Apr. 2, 2017 entitled “Unified Computing Device Interface and Method for Creation and Transfer of Digital Content from a Plurality of Sources to a Plurality of Target Destinations.” All of the foregoing applications are incorporated herein by reference in their entirety.

### FIELD

The embodiments of this disclosure are in the technical field of computing devices, encompassing both devices controlled by touchscreen input and devices controlled by moving cursor input. More specifically, the embodiments are in the technical field of interface design for control of electronic and electronically mediated systems.

### BACKGROUND

The use of Internet-connected computers as tools of communication and work implementation is now the norm worldwide across a broad range of usage in the realms of consumer, industrial, and medical products. In recent times this adoption has most significantly been due to increased availability of mobile computing options such as phones and tablet devices, and also including other types of devices controlled by touch-screens and alternative input means. Concurrently there has been a rapid increase in Internet-connectable or network-connectable “smart” devices, often referred to as the “Internet of Things.” There is a growing number of applications, notably for mobile phones and tablets, for connecting to and analyzing the output of various sensing, monitoring, and measurement devices for the purpose of health management and for scientific and engineering purposes. In view of these trends, the development of new types of highly intuitive and flexible user interfaces can further promote and optimize the usefulness of these technologies.

### SUMMARY OF THE DISCLOSURE

### A. Features of Parent Application Disclosure

The parent and subsequent disclosures describe a unified graphical user interface for assembly of digital source content and subsequent transmission to at least a subset of a plurality of network-based target destinations. The interface offers intuitiveness and ease-of-use while enabling highly configurable transmission of information for purposes of communication, data storage or data processing. The process may be initiated from the computing device using content newly created or stored on the device, or content accessible to the device via Internet or any form of network. The target destinations may be any connections accessible via Internet or any form of network to which the device has access, and may utilize the device's installed applications dedicated to specific communications services. Target destinations may be customized to associate at least one recipient with at least one, or a plurality of specific communication services. The proposed interface also serves as an alternate launcher for certain compatible types of applications installed on, or accessible from the same device.

B. Features of Current Disclosure Vs. Parent Application Disclosure

The current disclosure retains some of the more obvious graphical interface elements of earlier applications, and also retains a general concept of “sources” and “destinations.” However, in the current disclosure those concepts are broadened beyond message assembly and transmission, and include the concepts of signal routing and processing, and association of multiple factors or options with output results. Related concepts include signal management systems, matrix switching, “virtual patch cords,” and multi-input mixing. Although all these functions already have multiple solutions in place for implementation, the current disclosure proposes a new type of intuitive interface for achieving such functions, and which may provide a new level of benefits in some applications.

### BRIEF DESCRIPTION OF THE DRAWINGS

FIG. 1 depicts an embodiment of the invention in its default state, preceding interaction. One possible configuration of source entity icon and multiple destination entity icons is shown.

FIG. 2 depicts how additional icons not initially visible can be revealed and acted upon by a scrolling or paging motion.

FIG. 3a depicts one embodiment for specifying the identity of source entity for the source entity icon.

FIG. 3b depicts and additional embodiment for how multiple source entities may be displayed, by use of multiple icons.

FIG. 4 depicts one possible action for associating the source entity icon with three different destination entity icons, by dragging the source entity icon over the destination entity icons.

FIG. 5 depicts the result of dropping drag-and-drop control of the source entity icon, and additionally how a drag-and-drop selection can be canceled.

FIG. 6 depicts the interface elements in a state of having made selections, then allowing confirmation or cancellation, but also allowing for additional selections to be made.

FIG. 7 depicts how an additional selection from a different group of destination entity icons can be made.

FIG. 8 depicts the interface elements in a state of having made a total of 4 selections of association of source entity with destination entities, then allowing for final confirmation or cancellation, but also continuing to allow for additional selections to be made.

### DETAILED DESCRIPTION OF THE INVENTION

In the interest of providing clarity to those skilled in the art who will develop from the concept, significant detail is provided that is outside the bounds of specific claims but which supports successful implementation of the suggested embodiment and minor variations thereof.

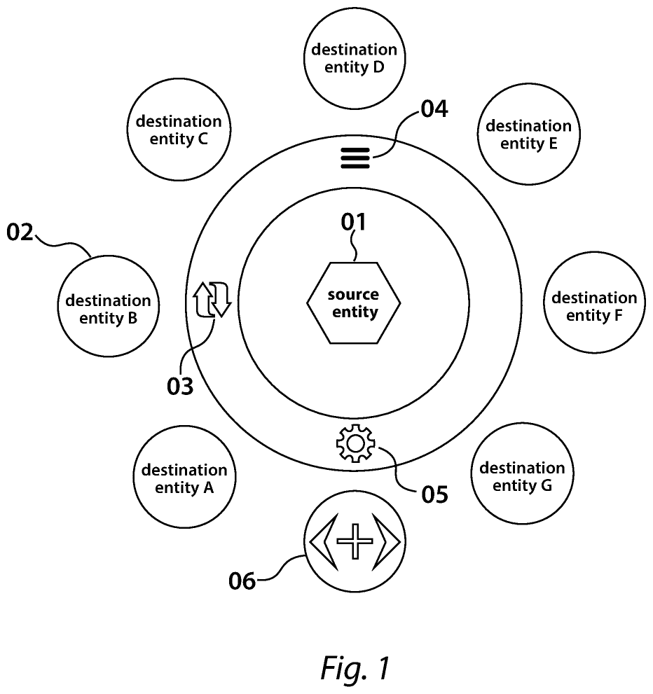

FIG. 1 depicts an embodiment of the invention in its default state, preceding user interaction. In this embodiment, a source entity icon 01 is in the central area, surrounded by a circular array of destination entity icons such as at 02. An icon button 03 allows the display of entity icons to be reversed, so that the central one is a destination entity while the ones in the circular array are source entities. Also displayed is a configuration menu 04 and settings or preferences menu 05. The configuration menu 04 is envisioned to include such functions as addition and configuring of source and destination entity icons, to determine what they actually represent. It may also include an option for saving particular combinations of actions, in the model of the “favorites” concept. The settings or preferences menu 04 is envisioned to include such functions as user preferences for various display aspects of the interface, or specifying default choices among multiple interaction options.

UX designers and code developers may choose to group configurable functions differently, and may choose to group all configurable functions under a single menu. The specific number of icons shown is nota characteristic of the invention, and may vary according to device display size and possibly also vary according to user preference settings.

A multi-action graphic button 06 provides a means for displaying additional entity icons in the circular array, when they exceed the number of icons displayable by this particular graphic layout. The action of this button is described more fully below.

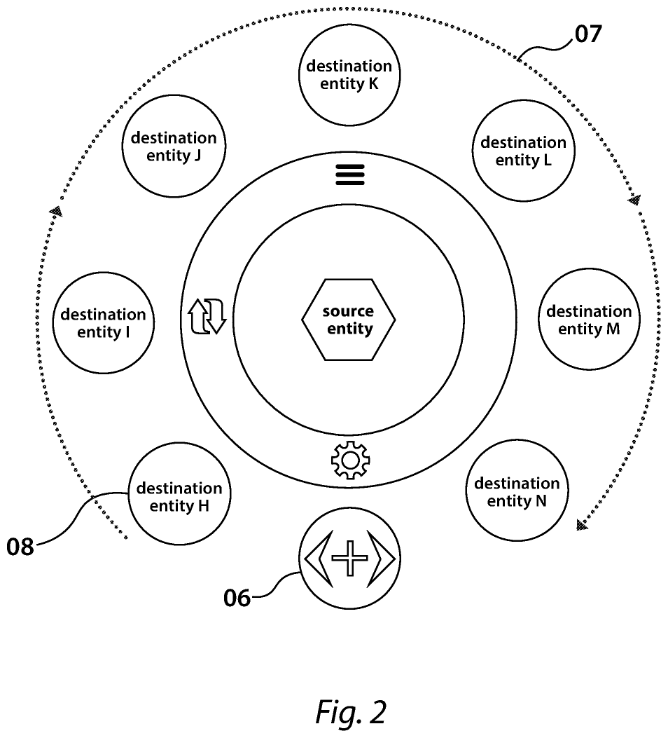

FIG. 2 repeats the overall layout of FIG. 01 but with emphasis on the method by which additional icons can be brought into view when the total number of icons in the circular array exceeds what can be displayed in the original graphic layout. The nature of the display change is either by a scrolling or paging action, or both provided as options. “Scrolling” is to be understood as the shifting of icons in a circular motion 07, so as to reveal at least one additional, previously unseen icon stored in configuration memory, while simultaneously hiding one of the originally displayed icons. The newly displayed icon will be on one side of the semicircular array, adjacent to button 06, and the icon previously appearing on the other side of 06 will disappear. Thus if two new icons are moved into view, two of the original icons will disappear from view. The side on which the new icon appears depends on whether a clockwise or anti-clockwise motion is chosen. “Paging” is to be understood as displaying an entirely different, full set of icons in a single action. In the case of this embodiment, a full set would be the next 7 icons, as shown here by the change of lettering of the “destination entity” labeling—showing H through N, instead of the earlier A through G. Button 06 provides the option to “scroll” in either direction, clockwise or anti-clockwise, according to the orientation of the two arrowhead symbols. A “paging” action is available by activating the central plus (+) symbol. The semicircular directional line 07 indicates a full-rotation paging action resulting from activating the paging option of button 06.

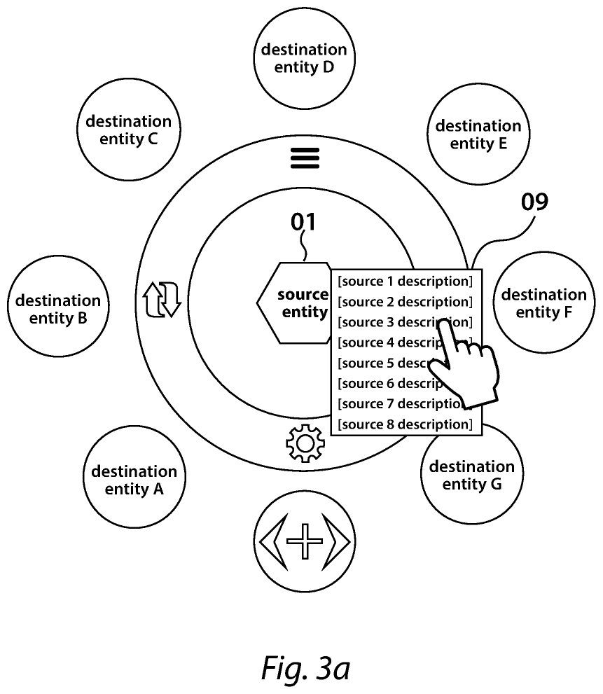

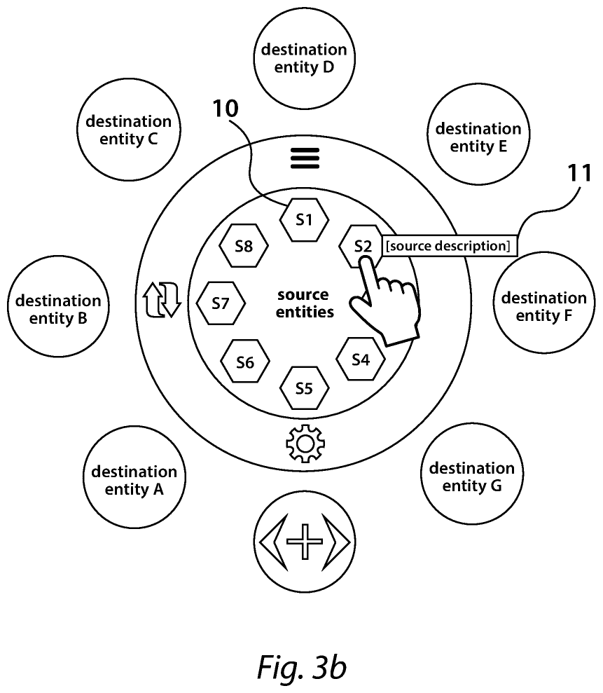

FIG. 3a details one of multiple possible embodiments for how the source entity icon 01 may be specified as to what exact source it refers to; in this case by a drop-down menu 09.

FIG. 3b details another of multiple possible embodiments for how the source entity icon 01 may be specified as to what exact source it refers to; in this case by displaying multiple, presumably frequently used icons such as 10. The actual identity of each one may conceivably be displayed momentarily by a touchscreen or cursor hover action, as suggested in 11, or may be constantly displayed if display space of particular devices allows for it.

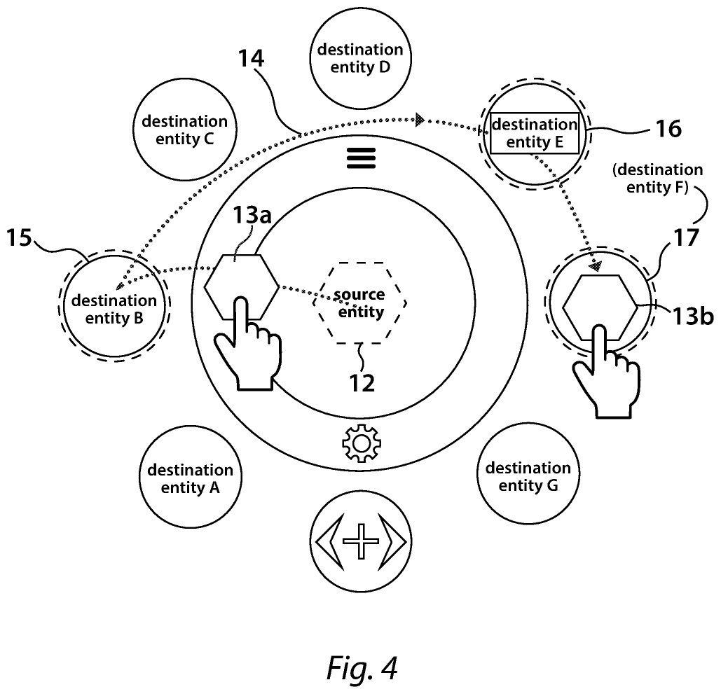

FIG. 4 depicts one of several methods by which the source entity can be associated with multiple destination entities. The method shown here can be either a “drag-and-drop” for a single destination entity, or “drag-hover-activate” followed by a final “drag-and-drop” action for a plurality of destination entities. The method is relevant to both cursor-control devices and to touchscreen devices, the differences being readily understood by those skilled in the art. In this depiction, a touchscreen method is implied.

The selected source entity icon 12 is here shown as its original, central position but represented as a dotted line shape because the actual icon 13a, being movable, is now in motion. In this case it is by touch contact and dragging. Following path 14, the icon is successively dragged over destination entity icons at 15, 16, and 17, finally ending up at position 13b. Dotted lines surrounding icons at 15, 16, and 17, represent that those destination entities have been selected for an association action. In some embodiments this may be implemented as a change of color, or addition of a color highlight or glow effect.

At this point, it is important to point out several practical considerations, and also several possibilities for embodiments which are not fully represented in drawings an their descriptions.

First, it would logically follow that not every source entity may be possible to be associated with every destination entity. Therefore, some form of constraints or “connection rules” would need to be enabled in the system being controlled by the interface, with such information being available to the interface in order to disallow such inappropriate associations and to notify the user accordingly.

Secondly, it would be desirable for such an interface as represented here to work in coordination with a graphic display of what connections are being made, such as in a network diagram. Many such displays already exist, therefore leveraging that kind of capability in association with this interface, would potentially enhance its usefulness in more complex forms of implementation. The use of such a graphic display would of course need to consider the type of device display, and whether or not display space can allow it, while maintaining realistic readability.

Thirdly, the actions represented and described are all in context of binary kinds of association and connections. In other words, either the source and destination entities are fully connected, or they are not. However, conceivably in some embodiments there would be a need to allow for variable mixing of source entities with destination entities. Therefore the interface may also include some form of variable control for accomplishing this for each such instance, such as an on-screen slider control which also allows direct numeric input.

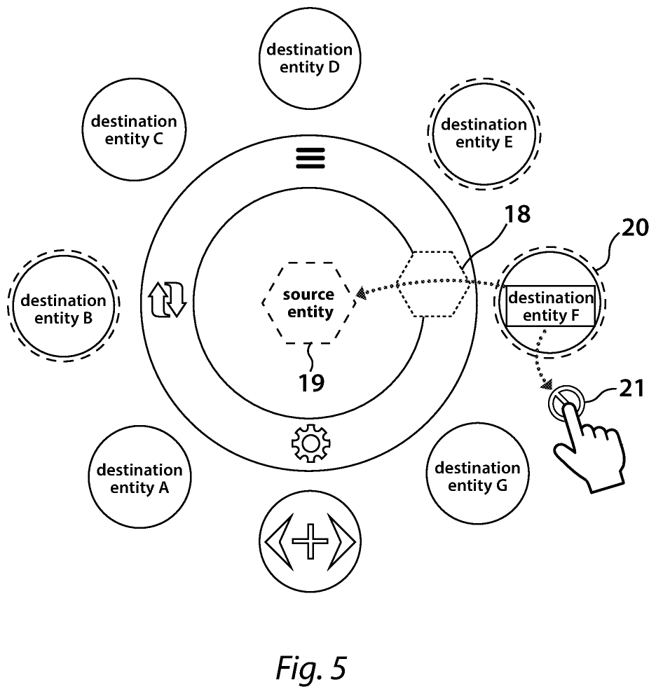

FIG. 5 depicts the result of releasing drag-and-drop control of the source entity icon 13b of FIG. 4, here renumbered as 18 because it is now in control of the system, not an icon being dragged. The icon is returning to central position 19, exhibiting a motion as if attached by a spring. “Releasing control” here means releasing touch contact with the icon, or in the case of cursor-control devices would mean releasing the primary mouse button or its equivalent in other control devices. The idea of icons being movable but being able to return to a default position in this suggested “spring-loaded” fashion is well established in the field of graphical user interfaces. The implication in this case is that all destination entity choices desired have been made among this particular group of options. Description of the next figure will cover cases where icons in other groups of destination entities, currently not visible, are also desired to be included in the total set of destinations to be acted upon.

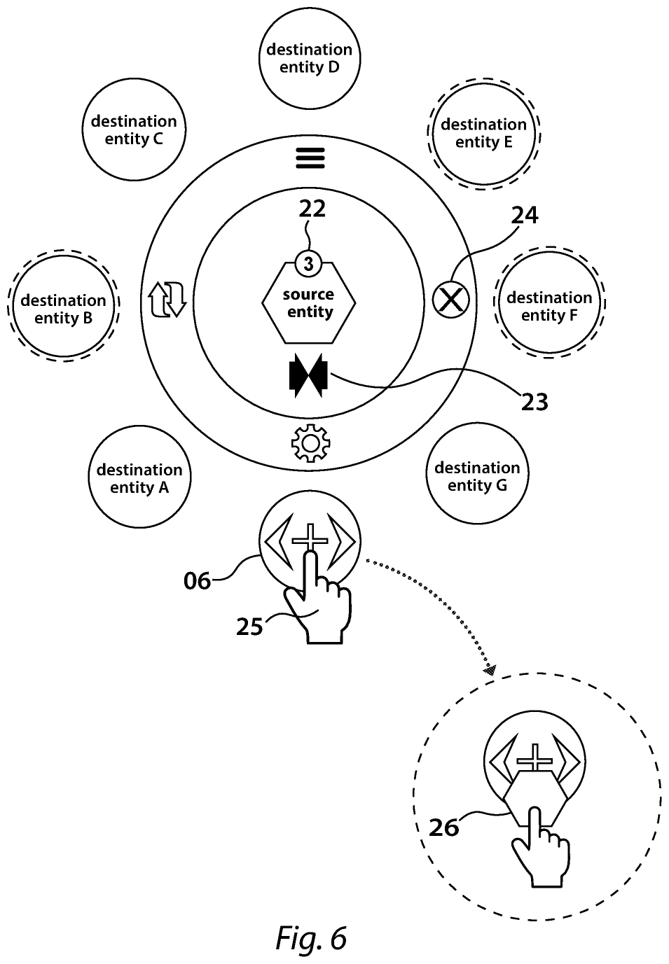

FIG. 6 depicts how additional destination entity icons, previously not visible in the interface, can be viewed and selected. First, the result of releasing the source entity icon 18 and its return to position 19 as described for FIG. 5 is that the icon displays a value “3” for the number of destination entity loaded, as seen at 22. This value could also, and preferably, be updated immediately upon activation of each destination entity icon. At this point, the procedural logic assumes the association of source entity with one or more destination entities is, or may be complete. Thus a button or link is displayed at 23, implying that the association and its logical actions can proceed if the button is activated. Button or link 24 provides an option to cancel all association actions previously configured.

However, it may be desired to load and select additional destination entities not visible in the default display. Such additional selections can be made by scrolling or paging to the next group of destination entity icons by touch or mouse-click action at 06, using either the full rotation action or the single item advance action as described in the discussion of FIG. 2. Optionally and more efficiently, if there is an intention to immediately proceed to the next group of destination entity icons and control of the source entity icon is not released as shown at 18 in FIG. 5, the icon could be positioned over the scrolling/paging button as in the inset detail 26 to execute the same action. The resulting advantage is that the icon is then immediately available to associate with additional destination entity icons in the next group.

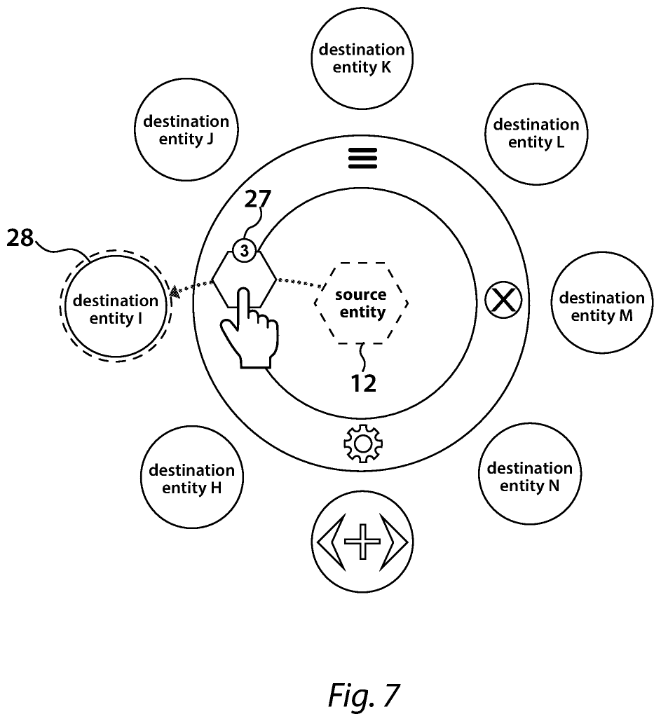

FIG. 7 depicts the selection of another destination entity icon to associate with the same source entity, after having executing a scrolling or paging action to display at least one of the next set of destination entity icons. The source entity icon, now represented in a new action 27, is picked up from the last-identified central position 12 and dragged to an additional destination entity icon 28; the result being the additional destination entity icon acquiring a highlight or other graphic change to confirm loading as a destination entity. If option 26 had been used in the previous step (FIG. 6), the picking-up step is unnecessary and the source entity icon can be immediately dragged to the additional destination entity icon. If no other destination entities in this group are needed, control of the source entity icon can be released. If additional destination entity icons in another group are needed, the same procedure as previously described can be followed for any additional selections needed.

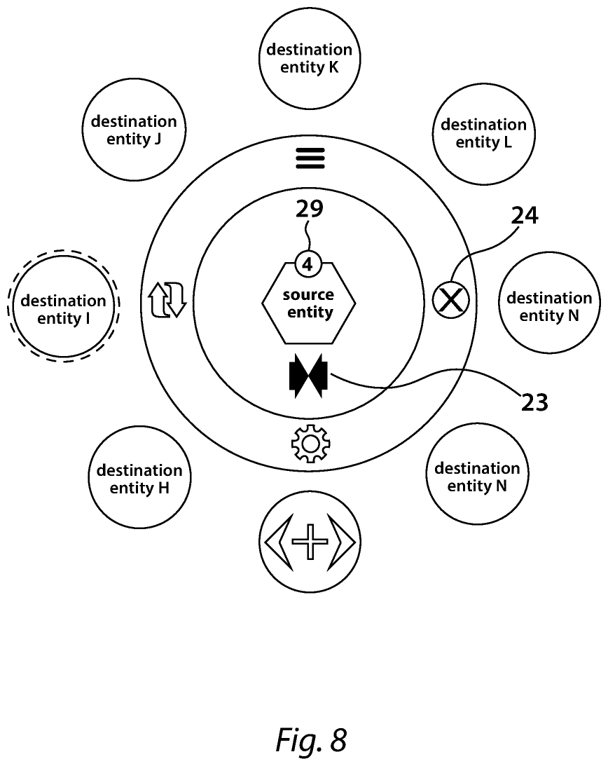

In FIG. 8 the selection of all desired associations of the source entity with destination entities has been completed, and control of the movable source entity icon has been released. The source entity icon is represented as renumbered icon 29 because it is now in control of the system as it automatically returns to the central position. The last group of destination entity icons accessed is still visible, and thus the last icon is shown by graphic emphasis as loaded, using the dotted line boundary as with the earlier selections in the first group. To confirm all previous selections, the source entity icon now displays a numeral “4” at 29, indicating a total of 4 destination entities loaded for association. At this point, activation of the button or link at 23 as previously described for FIG. 6, will execute the logical actions of association of source entity with the one or more destination entities. The source entity icon may also be “picked up” again to add more destination entities from this group, or any other group of destination entities, navigated to by any of the alternate means previously described. Optionally, all destination entities may be canceled with button or link 24. As a system configuration issue, selections could be automatically canceled by a time-out if not followed by a specific confirmation action within predetermined timeframe.

### Example Uses

The following is a non-exhaustive list of possible types of interaction that could be implemented in the proposed interface.
a) Used in the mode of a routing switcher, sending a selected signal to one or more selected ports or channels.
b) Used in the mode of a signal mixer, sending one or more selected signals to an output mix, with the intensity of the selected signals modified to specific levels.
c) Used in the mode of an options combination mixer to control electromechanical devices, controlling the output product of a vending machine for such products as coffee drinks, wherein multiple factors of choice may be combined.
d) Also in the mode of an options combination mixer to control electromechanical devices, controlling the output product of a custom manufacturing process, such as 3D printing of objects.

The invention claimed is:

1. A method for using a graphical user interface in a computing device to select at least one of a plurality of digitally-controllable source entities, and to associate the at least one source entity with at least one of a plurality of selected destination entities to enable functional connection therewith, the method comprising:
displaying within the graphical user interface a source entity selection interface, wherein said source entity is represented by at least one user-configurable and selectable icon;
displaying in the graphical user interface a destination entity selection interface, wherein said destination entity is represented by at least one user-configurable and selectable icon;
accepting input within the source entity selection interface to confirm selection of the at least one source entity;
accepting input within the source entity selection interface to confirm selection of the at least one destination entity;
accepting input within the graphical user interface for associating the at least one source entity with the at least one destination entity;
accepting input within the graphical user interface to confirm the implementation of a connection function of the at least one source entity with the at least one destination entity;
displaying at least one detail of the result of said connection association.

2. The method of claim 1, wherein if multiple source entities are selected, said multiple source entities are displayed as a single source entities icon representing the plurality of such source entities, and enabled to be selected for establishing an association with the at least one destination entity.

3. The method of claim 1, wherein if multiple destination entities are selected, said multiple destination entities are displayed as a single destination entities icon representing the plurality of such destination entities, and enabled to be selected for establishing an association with the at least one source entity.

4. The method of claim 1, wherein the at least one source entity icon is displayed as visually and temporally co-occurring with the at least one destination entity icon.

5. The method of claim 1, wherein either the source entity icons or the destination entity icons, when existing in multiple, are displayed as an array on a circular, elliptical, arc, or rectilinear path, wherein
the distance between any two adjacent of said icons along said path is within 50 to 200 percent of the equivalently-measured distance between any other two adjacent of said icons;
the distance between any one of said icons and the logical center of the circle, ellipse, arc, or rectilinear path is within the range of 25 to 400 percent of the equivalently-measured distance for any other of said icons.

6. The method of claim 5, wherein the at least one source entity icon is located centrally within the logical boundaries of the circular, elliptical, arc, or rectilinear array of the destination entity icons.

7. The method of claim 5, wherein the at least one destination entity icon is located centrally within the logical boundaries of the circular, elliptical, arc, or rectilinear array of the source entity icons.

8. The method of claim 5, wherein either the source entity icons or the destination entity icons, when existing in quantity such that not all are displayed simultaneously, are stored in memory and can be made visible or hidden by invoking an entity icon navigation function by, inclusively, either of
direct selection of a button or link activating said entity icon navigation function, causing display of additional of said previously hidden icons, or causing the hiding of said previously visible icons;
dragging of any one of said icons over a button or link activating said entity icon navigation function, causing display of additional of said previously hidden icons, or causing the hiding of said previously visible icons.

9. The method of claim 1, wherein all actions of selection are accomplished by detecting a means of user input selected from the group consisting of:
a) selection in a touchscreen display, comprising detection of haptic input, touch points, variable-force touch, or gestures;
b) selection in a touchscreen display, comprising detection of haptic input, touch points, variable-force touch, and gestures combined with drag-and-drop or drag-and-hover of the source entity icon over the one or more destination entity icons, or of the at least one destination entity icon over the one or more source entity icons, and optionally activating the entity icon navigation function;
c) selection of icons by a moving cursor, comprising detection of click actions;
d) selection of icons by a moving cursor, comprising detection of click actions combined with drag-and-drop or drag-and-hover of the source entity icon over the one or more destination entity icons, or of the at least one destination entity icon over the one or more source entity icons, and optionally activating the entity icon navigation function;
e) selection of icons by audio command;
f) selection of icons by eye-tracking control;
g) selection of icons by keyboard commands or other assistive technology;
h) combinations of any elements comprising those set forth in (a)-(g), inclusive.

10. The method of claim 1, wherein regardless of whether or not icons are displayed, the function for associating the at least one source entity with the at least one destination entity can be established by audio command.

11. The method of claim 1, wherein the entire graphical user interface described therein is displayed by superimposition over other screen content of the computing device and enabled to be hidden or revealed by input to any option selected from the group consisting of:
a) a button or link region within the computing device's display area;
b) alternative touchscreen input, such as variable force touch or multiple tap;
c) detection and processing of an audio command;
d) combinations of any elements comprising those set forth in (a)-(c), inclusive.
